(19) United States
(12) Patent Application Publication
(10) Pub. No.: US 2018/0019694 A1
(43) Pub. Date: Jan. 18, 2018

(54) SELECTIVELY CONFIGURABLE BRUSHLESS DC MOTOR

(71) Applicant: Mark A. Spickard, Carr, CO (US)

(72) Inventor: Mark A. Spickard, Carr, CO (US)

(73) Assignee: Woodward, Inc., Fort Collins, CO (US)

(21) Appl. No.: 15/213,157

(22) Filed: Jul. 18, 2016

(51) Int. Cl. H02P 25/18; H02K 3/28

(52) U.S. Cl. CPC H02P 25/184; H02K 3/28

(57) ABSTRACT

An actuator including a motor with a configurable topology and a switching array operably coupled to the motor. The switching array is adapted to configure the topology of the motor. The switching array may include a first set of switches for configuring the topology of the motor to a Y-configuration or a Δ-configuration and a second set of switches for configuring the topology of the motor to eliminate one or more stator poles of the motor. The switching array may further include a third set of switches for configuring the topology of the motor to activate a number of windings on each of a plurality of stator poles of the motor.

### FIELD OF THE INVENTION

This invention generally relates to motor driven valve and actuator assemblies and more particularly to a brushless DC motor driven valve.

### BACKGROUND OF THE INVENTION

A fuel valve, or a steam valve, that controls the energy rate into a turbine engine is typically positioned via an electro-mechanical servo system. A typical servo system may consist of a digital valve positioner (DVP) and a large electric linear actuator (LELA). The LELA consists of a motor, such as a brushless DC (BLDC) motor, and gear train that drives the actuation rod and a position feedback sensor. The DVP functions as the servo position controller in that it accepts a commanded position (from an upper level controller), senses the actual position (via the LELA feedback sensor) and drives the BLDC motor so that the actual position follows the commanded.

Generally, the primary goal of the servo system is to function as a slow speed, highly accurate position controller. In this mode, a high torque capability is desirable to track hard acceleration transients and to reject disturbances. Additionally, slow motor speed reduces the motor's back electro-motive voltage (V_{emf}). The result is a motor that potentially runs at high torque and current but with low speed and voltage. Accordingly, the power consumption is relatively low.

In the rare case of a failure, such as a load drop on the connected turbine, the servo system needs to close the valve quickly to prevent turbine overspeed. In the case of a fuel-burning turbine (as compared to a steam turbine) the valve must also be moved very accurately (i.e., no overshoot) so as to prevent loss of flame. Whatever the case, high speed slewing capability is a requirement. However, at high speed the motor's V_{emf} can be sufficiently high to tax the driver's voltage capability, thus minimizing the net voltage remaining to push current. Furthermore, conventionally, the servo system is spring biased to shut off such that, when slewing is closed, the motor torque and, consequently, the required current are low. Ultimately, high speed (i.e., voltage) is achieved but at low torque (current). Thus, power consumption is relatively low.

Generally, a motor must be selected for one application or the other, i.e., the motor provides high torque but low speed for precision position control of the valve, or high speed but low torque for increased motor speed. In practice, a motor that needs to perform both functions is a compromise between the two options. Unfortunately, such a compromised motor can lead to higher steady state currents at low speeds, increased gain of the position controller (and accompanying reduced stability margins), complicated software packages to provide a high torque motor with high speed capability, and complex and costly power electronics capable of increasing maximum rail voltage (again, to allow a high torque motor to operate at high speed). Another conventional option is to provide a high current, high voltage, and consequently high power driver even though high power is never actually needed because the capability to provide both high current (and thus high torque) and high voltage (and thus high speed) are never needed at the same time. Accordingly, a motor that can provide both high torque at low speeds and high speed with low torque without having the same disadvantages of conventional motors and control electronics would be beneficial, especially for turbine applications.

The invention provides such an improved motor capable of switching configurations to provide high torque for some applications and high speed for other applications. These and other advantages of the invention, as well as additional inventive features, will be apparent from the description of the invention provided herein.

### BRIEF SUMMARY OF THE INVENTION

In one aspect, an actuator is provided. The actuator includes a motor with a configurable topology and a switching array operably coupled to the motor. The switching array is adapted to configure the topology of the motor.

In an embodiment, the switching array includes a first set of switches for configuring the topology of the motor to a Y-configuration or a Δ-configuration and a second set of switches for configuring the topology of the motor, the motor having a number of active stator poles, to eliminate half of the active stator poles of the motor. Additionally, the second set of switches can be configured to further eliminate half of the remaining active stator poles of the motor. Also, in certain embodiments, the first set of switches is configured such that, in a default topology, the motor is in the Y-configuration. In certain other embodiments, the switching array can further include a third set of switches for configuring the topology of the motor to activate a number of windings on each of a plurality of stator poles of the motor. The number of windings on each of the plurality of stator poles can include a first part and a second part such that the third set of switches activates just the first part of the windings on each of the plurality of stator poles, just the second part of the windings on each of the plurality of stator poles, or both the first and second parts of the windings on each of the plurality of stator poles. Moreover, the first part can include a first number of windings and the second part can include a second number of windings with the first number being different than the second number.

In another embodiment of the actuator, the switching array includes a first set of switches for configuring the topology of the motor to a Y-configuration or a Δ-configuration and a second set of switches for configuring the topology of the motor to activate a number of windings on each of a plurality of stator poles of the motor. The number of windings on each of the plurality of stator poles can include a first part and a second part such that the second set of switches activates just the first part of the windings on each of the plurality of stator poles, just the second part of the windings on each of the plurality of stator poles, or both the first and second parts of the windings on each of the plurality of stator poles. Additionally, the first part can include a first number of windings and the second part can include a second number of windings with the first number being different than the second number. In certain embodiments, the first set of switches is configured such that, in a default topology, the motor is in the Y-configuration. In particular embodiments, the switching array can further include a third set of switches for configuring the topology of the motor, the motor having a number of active stator poles, to eliminate half of the active stator poles of the motor. In such a particular embodiment, the third set of switches can be configured to further eliminate half of the remaining active stator poles of the motor.

In yet another embodiment, the switching array can include a first set of switches for configuring the topology of the motor, the motor having a number of active stator poles, to eliminate half of the active stator poles of the motor and a second set of switches for configuring the topology of the motor to activate a number of windings on each of the stator poles of the motor. In said embodiment, the number of windings on each of the stator poles can include a first part and a second part such that the second set of switches activates just the first part of the windings on each of the plurality of stator poles, just the second part of the windings on each of the plurality of stator poles, or both the first and second parts of the windings on each of the plurality of stator poles. Further, the first part can include a first number of windings and the second part can include a second number of windings, the first number and the second number being different. The first set of switches can be configured to further eliminate half of the remaining active stator poles of the motor. In other embodiments, the switching array further can include a third set of switches for configuring the topology of the motor to a Y-configuration or a Δ-configuration. In said embodiments, the third set of switches can be configured such that, in a default topology, the motor is in the Y-configuration.

In still another embodiment, the actuator can further include a digital valve positioner (DVP) operably connected to the switching array. The switching array can include a first set of switches for configuring the topology of the motor to a Y-configuration or a Δ-configuration, a second set of switches for configuring the topology of the motor to eliminate one or more stator poles of the motor, and a third set of switches for configuring the topology of the motor to activate a number of windings on each of a plurality of stator poles of the motor. The DVP can command switching of the first, second, and third sets of switches. In such an embodiment, the DVP can be configured to command current in the windings to be zero amps and, upon reaching approximately zero amps, the controller can be configured to send a command to the switching array to configure the topology of the motor. In other embodiments, the actuator can further include a snubber for each switch of the first, second, and third sets of switches. The DVP can then be configured to send a command to the switching array to configure the topology of the motor at a non-zero current. In an additional embodiment, the switching array is configured to sense a current in the windings, the DVP is configured to send a command to the switching array to configure the topology of the motor, and the switching array configures the topology of the motor when the switching array senses that the current in the windings is crossing zero amps.

In further embodiment, for a given voltage, the motor topology can include at least a first set speed in a first topology, a second set speed in a second topology, and a third set speed in a third topology. Each of the set speeds are a no-load, maximum speed of the motor for each of the respective topologies. The first set speed is the slowest set speed and provides the highest torque of the motor topology. The second set speed provides the fastest set speed of the motor topology, and the third set speed is faster than the first set speed.

In a still further embodiment, the motor topology can include a first set speed in a first topology and a second set speed in a second topology. Each set speed is a no-load, maximum speed of the motor for each respective topology. The second set speed is between twelve and fifteen times higher than the first set speed.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 depicts a valve and actuator assembly according to an exemplary embodiment;

FIG. 2 depicts a stator and rotor combination for a brushless DC (BLDC) motor of an actuator according to an exemplary embodiment;

FIGS. 3A and 3B depict a schematic representation of a BLDC motor having three phases in a Δ-configuration and a Y-configuration, respectively, according to an exemplary embodiment;

FIG. 4 depicts a schematic representation of a BLDC motor including a digital valve positioner and external switching array for transitioning between the Y-configuration and the Δ-configuration, according to an exemplary embodiment;

FIG. 5 depicts the stator poles and associated windings for one phase of a 6/4 BLDC motor capable of Y to Δ transition, winding ratio adjustment, and stator pole elimination, according to an exemplary embodiment; and

FIG. 6 depicts the stator poles and associated windings for one phase of a 12/8 BLDC motor capable of Y to Δ transition, winding ratio adjustment, and stator pole elimination, according to an exemplary embodiment.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

A motor, such as a brushless DC (BLDC) motor and including switching and control systems, is provided that is capable of transitioning between high torque (for a given max driver current) operation and high speed (for a given max driver voltage) operation. Briefly, the motor is capable of transitioning between these modes of operation by selectively configuring the electrical connections of the windings of the stator poles (referred to herein as the “topology”) of the motor. As used herein, “selectively configurable” or “selectively configured” means that the topology (i.e., the electrical connections between the windings of the stator poles and/or parts of the windings of the stator poles) can be adjusted to produce a different configuration of the stator pole windings and an accompanying change in torque and/or speed of the motor's operation. For instance, the windings of the stator poles can be selectively configured between the Y-configuration and the Δ-configuration. Additionally, the motor is selectively configured to adjust the winding ratio of the induction coils defined by the windings of the stator poles and/or eliminating the number of poles so as to provide a plurality of “gears” through which the motor can be gradually transitioned, thereby enhancing the power that can be transferred to the motor while staying within the voltage and current limits of the driver. While the motor is described primarily in the context of an actuator for a valve, the disclosure is not intended to be read as limiting the applications of the motor and other applications will be readily apparent to a person having ordinary skill in the art.

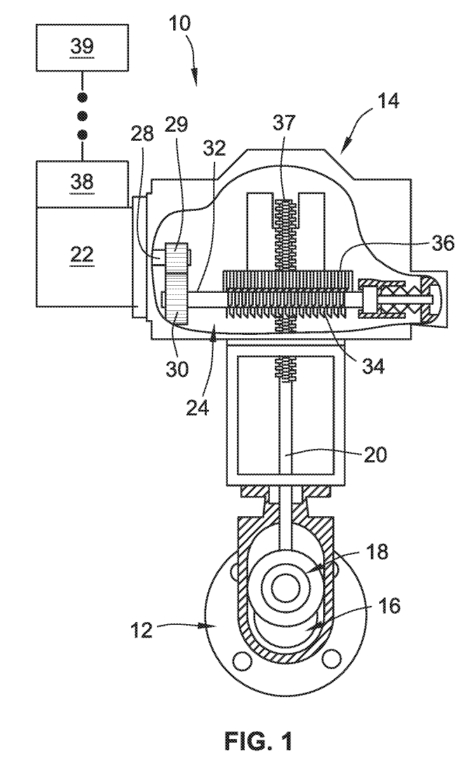

FIG. 1 depicts a valve and actuator assembly 10 having a valve 12 and an actuator 14. The valve 12 controls the amount of flow through a valve aperture 16. The valve 12 is interposed on a fluid (gases or liquids) communication line, such as a pipe, conduit, channel, duct, main, etc. The fluid communication line can carry any of a variety of fluids, including fuel, steam, and water, among others. In an embodiment, the fluid communication line is a fuel line (e.g., combustible hydrocarbon fuel or steam) for a turbine.

In the embodiment depicted in FIG. 1, the valve 12 is a gate valve in which a disk 18 moves up and down (relative to the orientation of the valve and actuator assembly 10 as depicted in FIG. 1) to permit a variable amount of flow through the aperture 16. In preferred embodiments, the disk 18 moves upward far enough to allow fluid flow through a completely unobstructed aperture 16. Additionally, in preferred embodiments, the disk 18 can completely block fluid flow through the aperture 16. While a gate valve is depicted, other valves could also be utilized, including a globe valve, ball valve, butterfly valve, plug valve, and diaphragm valve, among others.

The disk 18 moves upwards and downwards through actuation of an actuation rod 20. The actuation rod 20 is in mechanical communication with the actuator 14. A motor 22, which is a BLDC motor in this embodiment, causes movement of the actuation rod 20 through a mechanical linkage 24. The mechanical linkage 24 can be any of a variety of suitable mechanical linkages. As depicted in FIG. 1, the mechanical linkage 24 is a gear train that includes a spur gear 29 on the driveshaft 28 of the BLDC motor 22 that communicates with another spur gear 30. The spur gear 30 has a central wormshaft 32 with a worm 34 that communicates with a worm gear 36. The worm gear 36 engages a threaded end 37 of the actuation rod 20. Thus, rotational force from the BLDC motor 22 is translated through the mechanical linkage 24 to cause the actuation rod 20, and consequently the disk 18, to move upwards and downwards, thereby varying fluid flow through the aperture 16 of the valve 12.

In embodiments, a digital valve positioner (DVP) 38 accepts a commanded position for the valve 12 from an upper level controller 39. In response, the DVP 38 senses the actual position of the valve 12, or alternately the position of the motor 22 (which is directly proportional to the position of the valve 12), via a feedback sensor located on the actuator 14 or the motor 22. Then, through position controllers, current controllers, and voltage drivers located in the DVP 38, the DVP 38 drives the BLDC motor 22 such that the actual position follows the commanded position.

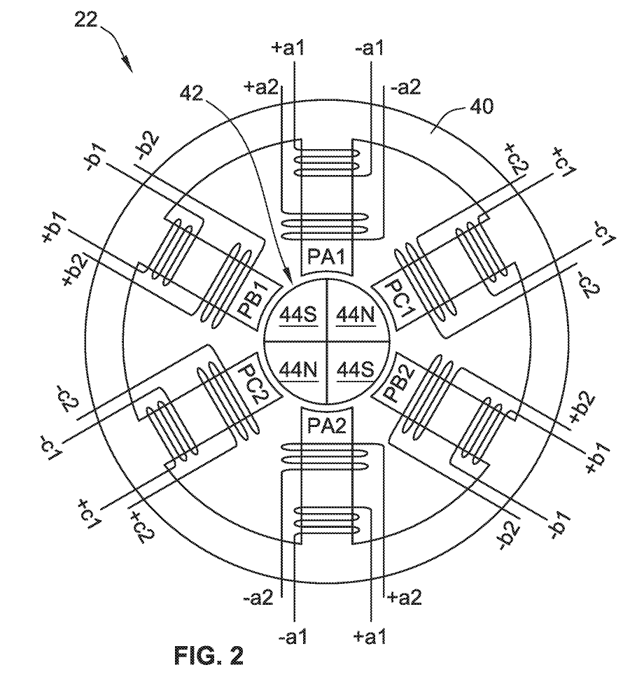

FIG. 2 depicts an embodiment of the BLDC motor 22 having a stator 40 with six stator poles PA1, PA2, PB1, PB2, PC1, PC2 and a permanent magnet rotor 42 having four poles 44N, 44S. As used herein, the stator and rotor poles having such a configuration will be referred to as “6/4” to denote that the motor has six stator poles and four rotor poles. A BLDC motor with three stator poles and two rotor poles would analogously be referred to as “3/2” and twelve stator poles and eight rotor poles as “12/8.” Each of the stator poles include induction coils comprised of a plurality of wire windings depicted as phase coils a1, a2, b1, b2, c1, c2. The winding of a coil can be wrapped entirely around one stator pole, as they would be for a 3/2 motor, or split between two stator poles as they are for the 6/4 motor in FIG. 2, or split between four stator poles as they would be for a 12/8 motor. In general, a BLDC motor 22 works by changing the magnetic field produced at the stator poles PA1, PA2, PB1, PB2, PC1, PC2 as a result of current flowing through the wire windings of the phase coils a1, a2, b1, b2, c1, c2. The changing magnetic field induces rotation of the rotor 42 through the interaction between the magnetic field produced by the phase coils a1, a2, b1, b2, c1, c2 and the poles 44N, 44S of the permanent magnet rotor 42. In other embodiments, the stator 40 can have more or less poles and windings. Additionally, in other embodiments, rotor 42 can have more or less than the four poles depicted in FIG. 2.

As discussed above, the use of a1, a2, b1, b2, c1, c2 denotes coils of windings, that are wrapped around the poles PA1, PA2, PB1, PB2, PC1, PC2, and which conduct the currents of the three phases with a1 and a2 constituting the “a” phase, b1 and b2 the “b” phase, and c1 and c2 the “c” phase. Generally, each phase is separated by 120 electrical degrees, meaning that voltages are applied so that the resulting sinusoidal phase currents in the three phases are separated by 120 electrical degrees. For a 3/2 motor, 360 electrical degrees will rotate the stator flux vector 360 physical degrees and thus rotate the rotor 360 physical degrees. For a 6/4 motor, 360 electrical degrees will only rotate the flux vector, and thus the rotor, 180 physical degrees. For a 12/8 motor, 360 electrical degrees will rotate the rotor 90 physical degrees. Position sensors, such as a resolver, monitor the position of the rotor 42 and send the value back to both a position controller and a current controller within the DVP 38.

The position controller compares the demanded position from the upper level controller 39 to the actual position from the position sensor. The resulting position error is then converted into a current demand by the position controller. The current demand is sent to the current controller and is designed to drive the motor in the required direction that will minimize the position error. Current sensors monitor the phase currents and send the values back to the current controller in the DVP 38. The current controller compares the current demand from the position controller to the actual current from the sensors. The current error is then converted into a voltage demand by the current controller. The voltage demand is sent to the voltage controller and is designed to drive the phase currents so as to minimize the current error. The voltage is also manipulated as a function of the rotor position (which was sent to both the position controller and the voltage controller) so as to assure the resulting phase currents, and thus stator flux vector, is positioned relative to the rotor flux vector for maximum torque per amp, and thus maximum motor efficiency.

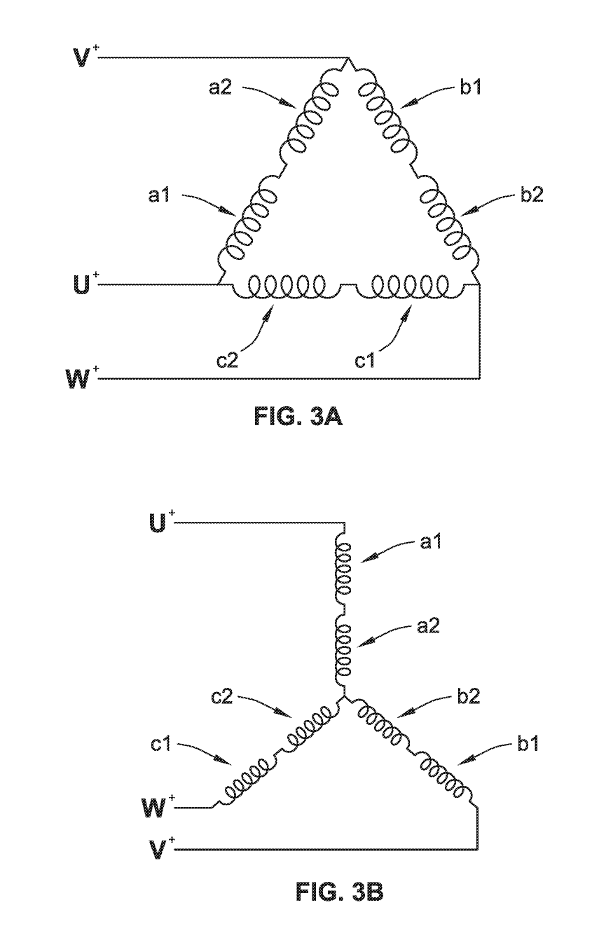

The electrical connections between the windings of the phase coils a1, a2, b1, b2, c1, c2 are configured to switch between a Y-configuration and a Δ-configuration. The Y-configuration allows the motor 22 to generate relatively higher torque at low speed, while the Δ-configuration allows the motor 22 to produce relatively higher speed with lower torque. Generally, the motor configuration, Y or Δ, is chosen for the motor's specific application, i.e., a Y-configuration is chosen where the torque is necessary for precision position control or other performance factors, and the Δ-configuration is chosen where speed is of greater importance for the particular application. As depicted schematically in FIG. 3A, the phase coils a1, a2, b1, b2, c1, c2 are configured in the Δ-configuration, and as depicted schematically in FIG. 3B, the phase coils a1, a2, b1, b2, c1, c2 are configured in the Y-configuration.

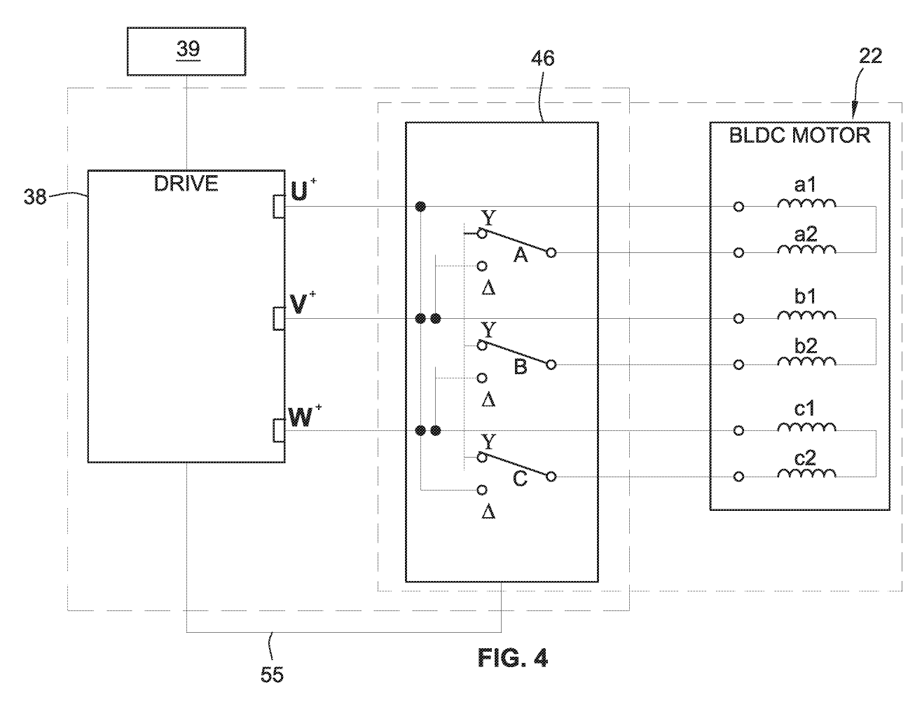

As depicted in FIG. 4, in order to provide both high torque at low speeds and to increase the available speed of the BLDC motor 22, the BLDC motor 22 includes a switching array 46 that allows the motor topology to switch between the Y-configuration and the Δ-configuration. As denoted by the dashed box around the switching array 46 and the BLDC motor 22, the switching array 46 and motor 22 can be an integral unit, or in certain embodiments, the switching array 46 can be external to the BLDC motor 22. Furthermore, as denoted by a second dashed box around the switching array 46 and the DVP 38, the switching array 46 could be internal to the DVP 38. The switching array 46 can be controlled by a variety of logic controllers, including a field programmable gate array (FPGA), an application-specific instruction set processor (ASIP), etc. The controller would assure correct sequencing and make-brake timing of the switches. Furthermore, the controller board would include the physical switches (e.g., MOSFET, etc.) and any protection circuits that may be needed to protect the switches from high voltage switching transients.

The switching array 46 receives signals from the DVP 38, which includes a plurality of current controllers having terminals U+, V+, and W+. The switching array 46 may also receive a “switch” command from the DVP 38 to control when the switching events, i.e., transitioning from one “gear” to another, occur. Alternatively, the switch command may be determined by the logic controller within the switching array 46 itself. In this way, for instance, the BLDC motor 22 can operate in the Y-configuration during start-up and transition to the Δ-configuration to increase the speed of the BLDC motor 22. In terms of relative speed for a given voltage, the BLDC motor 22 can operate at a maximum, no-load speed ωᵣ_{_}ₙₒₘ when in the Y-configuration. By transitioning to the Δ-configuration, the BLDC motor 22 can operate at a relative speed of ωᵣ_{_}ₙₒₘ.

Besides switching between the Y-configuration and the Δ-configuration, the rotational speed of the BLDC motor 22 can be increased in a variety of other ways, including stator pole elimination and winding ratio adjustment. As used herein, “stator pole elimination” refers to the reduction in the number of active stator poles, via a turning-off of the phase coils that are wrapped around the stator pole, driving rotation of the rotor 42. Generally, the number of poles will be a multiple of the number of current phases, e.g., for a three-phase BLDC motor, the number of stator poles will be a multiple of three. During pole elimination of a three-phase BLDC motor 22, half of the stator poles are eliminated. For example, in the six stator pole embodiment of FIG. 2 having stator poles PA1, PA2, PB1, PB2, PC1, PC2, stator poles PC1, PA2, PB1 will be turned off, and active stator poles PA1, PB2, PC2 will drive rotation of the rotor 42. Also as used herein, “winding ratio adjustment” refers to increasing or decreasing the number of windings through which current flows in the phase coils wrapped around the stator poles. For instance, as depicted in FIG. 2 and FIGS. 5 and 6 (discussed below), current can be provided to both phase coils (e.g., both phase coils a1, a2 of stator pole PA1) of a stator pole, or current can be provided to just one phase coil (e.g., either phase coil a1 or a2 of stator pole PA1) of a stator pole.

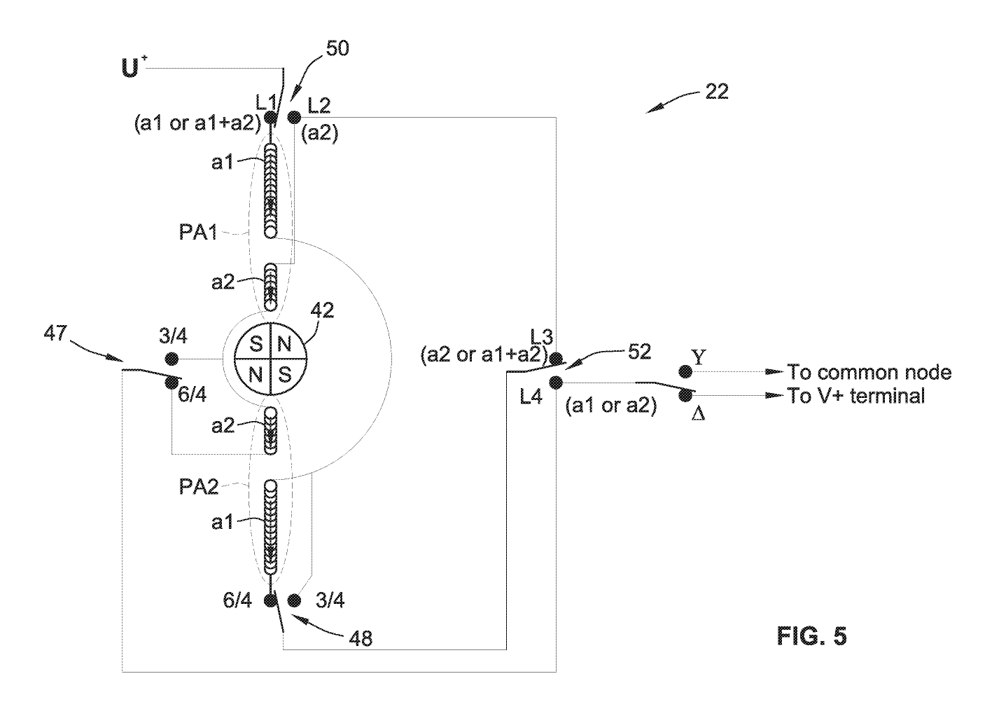

FIG. 5 depicts configurable BLDC motor 22 capable of stator pole elimination. As can be seen in FIG. 5, a single phase (the “a” phase) of the motor 22 is shown, which includes stator poles PA1, PA2 and their associated coils a1, a2. The other two phases (the “b” phase and the “c” phase) would be substantially the same as the single phase depicted. The speed of the BLDC motor 22 can be varied by varying the number of active stator poles, which can be selected using a first switch 47 and a second switch 48. As can be seen in FIG. 5, the first and second switches 47,48 provide for the selection of either six active stator poles (i.e., 6/4 configuration) or three active stator poles (i.e., 3/4 configuration). When switched to the three active stator pole configuration, the first and second switches 47,48 cause the stator pole PA2 to be bypassed such that no current from terminal U+ is supplied to the a1 and a2 coils that are wrapped around PA2. Current is still supplied to the a1 and a2 coils wrapped around PA1. In a motor with six active stator poles and for a given voltage, the maximum, no-load speed will be ωᵣ_{_}ₙₒₘ. When only half the poles are active, then the maximum, no-load speed is ωᵣ_{_}ₙₒₘ If, for instance, the motor 22 had twelve stator poles, then only a quarter of the poles can be made active for a maximum, no-load speed of ωᵣ=4ωᵣ_{_}ₙₒₘ. The first and second switches 47,48 depicted in FIG. 5 can be included on the switching array 46 (depicted in FIG. 4), which, as discussed above, can be either external or internal to the BLDC motor 22 or DVP 38.

FIG. 5 also depicts a configurable BLDC motor 22 capable of winding ratio adjustment. Using winding ratio adjustment, the speed of the BLDC motor 22 can further be manipulated by adjusting the number of windings wrapped around the stator poles through which current flows via selection of both phase coils a1 and a2 or via selection of just one phase coil, a1 or a2. The total number of wire windings having N number of turns wrapped around the stator poles is comprised of the number of turns N1 in the phase coil a1 and the number of turns N2 in the phase coil a2. The ratio of active wire windings (i.e., wire windings through which current flows during operation of the motor 22) for each stator pole can be adjusted by selecting either phase coil a1 (N1 turns) or phase coil a2 (N2 turns) or both phase coils a1, a2 (N1+N2=N turns). As used herein, the winding ratio R is N1/N2. For a BLDC motor 22 operating at a given voltage and in which the both the phase coils a1, a2 experience the same current, the BLDC motor 22 has a maximum, no-load speed of ωᵣ_{_}ₙₒₘ. If the phase coil a2 is turned off, the BLDC motor 22 has a maximum, no-load speed ωᵣ=ωᵣ_{_}ₙₒₘ(R+1)/R. If the phase coil a1 is turned off, the BLDC motor 22 has a maximum, no-load speed ωᵣ=ωᵣ_{_}ₙₒₘ(R+1). For example, where the ratio winding ratio R is 3, i.e., the number of turns N1 for the phase coil a1 is three times more than the number of turns N2 for the phase coil a2, then the max speed of the motor would be ωᵣ=1.33ωᵣ_{_}ₙₒₘ and ωᵣ=4ωᵣ_{_}ₙₒₘ when the phase coil a2 and the phase coil a1 are turned off, respectively.

Selection of either the phase coil a1, the phase coil a2, or both the phase coil a1 and phase coil a2 for the stator poles PA1, PA2, or just the stator pole PA1 (if stator pole elimination has turned off all coils on the stator pole PA2) is accomplished via a third switch 50 and a fourth switch 52. The third switch 50 is a single pole, double throw switch with leads L1 and L2. The fourth switch 52 is also a single pole, double throw switch with leads L3 and L4. The third switch 50 is set to lead L1 and the fourth switch 52 is set to lead L3 to provide current to both phase coil a1 and phase coil a2. The third switch 50 is set to lead L1 and the fourth switch 52 is set to lead L4 to provide current to just phase coil a1. The third switch 50 is set to lead L2 and the fourth switch 52 is set to either lead L3 or L4 to provide current to just phase coil a2. The third and fourth switches 50,52 depicted in FIG. 5 can be included on the switching array 46 (depicted in FIG. 4), which, as discussed above, can be either external or internal to the BLDC motor 22 or the DVP 38.

Returning to FIG. 4, the BLDC motor 22 having the capability of switching between Y-configuration and Δ-configuration requires six wire leads. In order to provide the above-described pole elimination and Y to Δ transition, Table 1 provides the number of necessary leads for a three-phase BLDC motor 22. To include the capability of winding ratio adjustment, in any of the embodiments depicted in Table 1, then the number of leads required is doubled.

TABLE 1
Lead Requirement for Configurable BLDC Motor

| Motor Functionality | Leads Required |
|---|---|
| Stator pole elimination from 6 to 3 | 9 |
| Y to Δ with stator pole elimination from 6 to 3 | 9 |
| Stator pole elimination from 12 to 6 | 9 |
| Y to Δ with stator pole elimination from 12 to 6 | 9 |
| Stator pole elimination from 12 to 6 to 3 | 18 |
| Y to Δ with stator pole elimination from 12 to 6 to 3 | 18 |

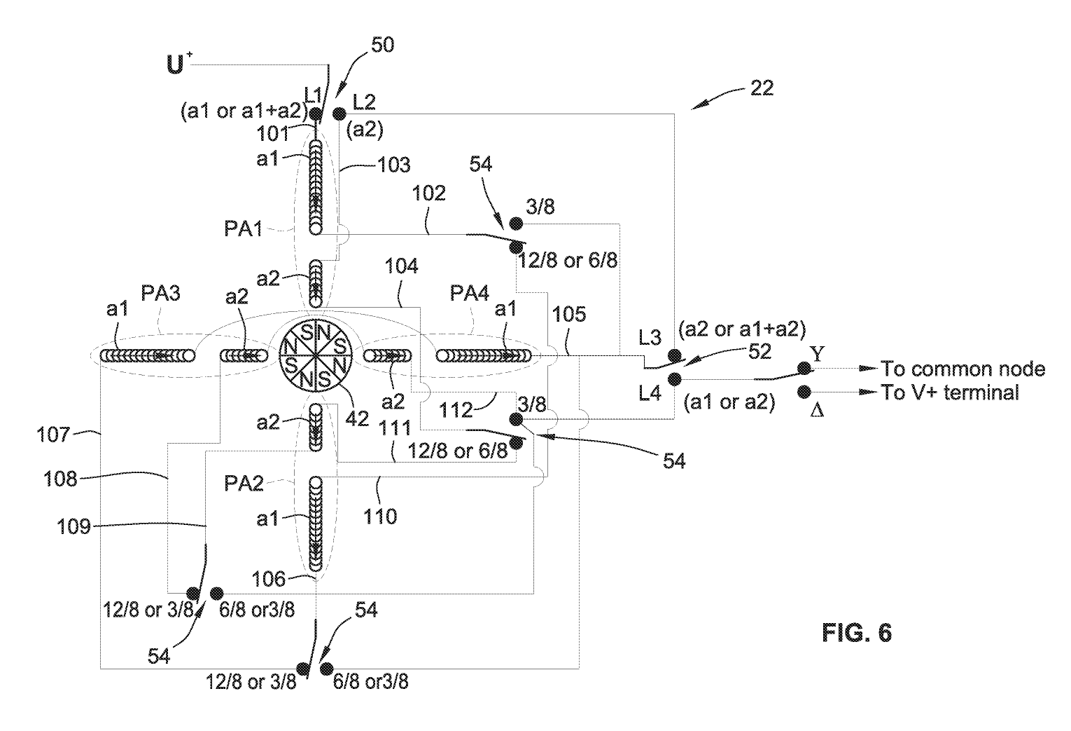

As Table 1 demonstrates, more leads are required as motor functionality increases. In addition to the increasing number of leads, the switching array 46 will also need to include additional switches to selectively activate each aspect of the functionality. FIG. 6 depicts a single-phase of a BLDC motor 22 with Y to Δ, stator pole elimination from 12/8 to 6/8 to 3/8, and winding ratio adjustment capability, and vice versa. As can be seen in FIG. 6, the single phase requires twelve leads as identified by the numbers 101 through 112. Thus, for all three phases of the BLDC motor 22, the total number of leads would be thirty-six. Only two switches, third switch 50 with leads L1 and L2 and fourth switch 52 with leads L3 and L4, are needed for winding ratio adjustment. Also, as with the 6/4 embodiment depicted in FIG. 5, the selection of the phase coil a1, phase coil a2, or phase coil a1 and phase coil a2 is accomplished using the same lead connections for the third and fourth switches 50, 52. However, as depicted in FIG. 6, four switches 54 are needed to provide pole elimination for the 12/8 BLDC motor 22 instead of just the two switches (first switch 47 and second switch 48) used in the 6/4 embodiment of FIG. 5. As in prior embodiments, the switches 50, 52, 54 of the 12/8 BLDC motor 22 embodiment of FIG. 6 can be included on a switching array 46 (depicted in FIG. 4), which, as discussed above, can be either external or internal to the BLDC motor 22 or DVP 38.

Transitioning between the Y- and Δ-configurations, eliminating poles, and adjusting the winding ratio of energized winding coils can be accomplished through a variety of control schemes. Generally, the system on which the valve and actuator assembly is installed includes a DVP 38 (as depicted schematically in FIG. 1) that controls all motor operation. As discussed below, the DVP 38 can interact with the switching array to switch the electrical connections between the phase coils to produce the desired configuration.

With reference to FIG. 4, in an embodiment, the DVP 38 determines the optimum switch speed for reconfiguring the windings of the stator poles of the BLDC motor 22. In one option, the DVP 38 opens its position control loop (i.e., comparison of the commanded position with position sensed with the actuator/motor sensor) and positively commands 0 Å to the current controllers so that the energy in the phase coils is low enough that there are no significant switching induced voltage transients. Once current reaches approximately 0 A, a bit command is sent via a command line 55 to the switching array 46 that performs the actual switching of the motor topology. Logic changes in the DVP 38, if any, are also performed at this time. The switching array 46 could be a field programmable gate array (FPGA) type with analog switching circuits. The FPGA would control the sequencing and make-brake timing of the switches. After switching of the motor topology, the position control loop of the DVP 38 is then reclosed, and the DVP 38 starts commanding the desired current.

In another embodiment, the DVP 38 determines the optimum switch speed and simply sends a bit command via the command line 55 to the switching array 46 to perform the switching. Any logic changes in the DVP 38 are performed when the bit command is sent. By comparison to the previous embodiment, the current is not commanded to 0 A, so in this embodiment, switch protection is necessary. As in the previous embodiment, the switching array 46 could be an FPGA type with analog switching circuits, which converts the bit command into switching command with the correct sequencing and timing. In embodiments, switches can be protected from voltage transients by protection circuits, such as snubbers, including RC snubbers, etc.

In still another embodiment, the DVP 38 determines the optimum switch speed and sends a bit command via the command line 55 to the switching array 46 that has current sensing capability. At that time, the DVP 38 also performs any necessary logic changes. The switching array 46, such as an FPGA, not only performs the sequencing and timing of the switches, but it also waits to send its switch commands until the exact time that the phase currents cross 0 A, thereby eliminating switching induced voltage transients.

In yet another embodiment, the switching array 46, instead of the DVP 38, determines the switch point and commands switches as current crosses 0 A. In such an embodiment, the switching array 46 includes internal logic or a processor for determining the switch point and commanding the switches as current crosses 0 A. Additionally, the switching array 46 has power electronics for shifting terminal currents by 30 electrical degrees, or biases the rotor feedback, for Δ-configuration as is needed since the terminal currents and phase currents are 30 electrical degrees out of phase for the Δ-configuration. The entire switching array 46 is separate from the DVP 38, which means that the DVP 38 can be unchanged.

### Example

In an exemplary embodiment, a BLDC motor with six stator poles and four rotor poles, i.e., 6/4 configuration, is provided. The BLDC motor 22 has the capability of switching topologies between Y- and Δ-configurations, pole elimination from 6/4 to 3/4, and winding ratio adjustment. For this example, the winding ratio R is N1/N2=3, i.e., phase coils a1, b1, c1 have three times more windings than phase coils a2, b2, c2. For a BLDC motor 22 starting in a Y-configuration with all windings and all stator poles active, the nominative speed of the rotor 42 is ωᵣ_{_}ₙₒₘ. Table 2 shows the relative speed capability of the BLDC motor 22 as the stator poles are transitioned through a number of configurations, denoted as “gears” in column one. The “set speed” referred to in the last column is the maximum, no-load speed of the motor for a given applied voltage. For this particular BLDC motor 22, the motor topology can be configured to produce twelve gears.

TABLE 2
Rotor Set Speeds based on Motor Topology

| Gear | Stator Config. | Phase coils | Stator Poles | Set Speed |
|---|---|---|---|---|
| 1 | Y | Full | 6 | ωᵣ_{_{—}}ₙₒₘ |
| 2 | Y | a1, b1, c1 | 6 | 1.33ωᵣ_{_{—}}ₙₒₘ |
| 3 | Δ | Full | 6 | 1.73ωᵣ_{_{—}}ₙₒₘ |
| 4 | Y | Full | 3 | 2ωᵣ_{_{—}}ₙₒₘ |
| 5 | Δ | a1, b1, c1 | 6 | 2.3ωᵣ_{_{—}}ₙₒₘ |
| 6 | Y | a1, b1, c1 | 3 | 2.66ωᵣ_{_{—}}ₙₒₘ |
| 7 | Δ | Full | 3 | 3.46ωᵣ_{_{—}}ₙₒₘ |
| 8 | Y | a2, b2, c2 | 6 | 4ωᵣ_{_{—}}ₙₒₘ |
| 9 | Δ | a1, b1, c1 | 3 | 4.6ωᵣ_{_{—}}ₙₒₘ |
| 10 | Δ | a2, b2, c2 | 6 | 6.92ωᵣ_{_{—}}ₙₒₘ |
| 11 | Y | a2, b2, c2 | 3 | 8ωᵣ_{_{—}}ₙₒₘ |
| 12 | Δ | a2, b2, c2 | 3 | 13.84ωᵣ_{_{—}}ₙₒₘ |

*Full denotes all phase coils, a1, a2, b1, b2, c1, c2

As Table 2 demonstrates, the BLDC motor 22 can vary the rotor speed up to almost fourteen times the nominative operating speed. Thus, a valve and actuator assembly 10 (as depicted in FIG. 1) incorporating the selectively configurable BLDC motor 22 of the present disclosure can provide high torque at low speeds while also providing configurations for high speed operation. Such a valve and actuator assembly 10 can be used on a variety of fluid communication lines, such as a fuel line for a turbine. In this exemplary embodiment, the valve and actuator assembly 10 can provide the high torque necessary for precision operation of the valve during normal operation, while also providing high speed operation to quickly close the valve 12 and prevent turbine overspeed during a failure.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. (canceled)

2. An actuator, comprising:
a motor with a configurable topology; and
a switching array operably coupled to the motor, the switching array adapted to configure the topology of the motor;
wherein the switching array includes a first set of switches for configuring the topology of the motor to a Y-configuration or a Δ-configuration and a second set of switches for configuring the topology of the motor, the motor having a number of active stator poles, to eliminate half of the active stator poles of the motor.

3. The actuator of claim 2, wherein the second set of switches are configured to further eliminate half of the remaining active stator poles of the motor.

4. The actuator of claim 2, wherein the first set of switches is configured such that, in a default topology, the motor is in the Y-configuration.

5. The actuator of claim 2, wherein the switching array further includes a third set of switches for configuring the topology of the motor to activate a number of windings on each of a plurality of stator poles of the motor.

6. The actuator of claim 5, wherein the number of windings on each of the plurality of stator poles include a first part and a second part and wherein the third set of switches activates just the first part of the windings on each of the plurality of stator poles, just the second part of the windings on each of the plurality of stator poles, or both the first and second parts of the windings on each of the plurality of stator poles.

7. The actuator of claim 6, wherein the first part includes a first number of windings and the second part includes a second number of windings, the first number being different than the second number.

8. An actuator, comprising:
a motor with a configurable topology; and
a switching array operably coupled to the motor, the switching array adapted to configure the topology of the motor;
wherein the switching array includes a first set of switches for configuring the topology of the motor to a Y-configuration or a Δ-configuration and a second set of switches for configuring the topology of the motor to activate a number of windings on each of a plurality of stator poles of the motor.

9. The actuator of claim 8, wherein the number of windings on each of the plurality of stator poles include a first part and a second part and wherein the second set of switches activates just the first part of the windings on each of the plurality of stator poles, just the second part of the windings on each of the plurality of stator poles, or both the first and second parts of the windings on each of the plurality of stator poles.

10. The actuator of claim 9, wherein the first part includes a first number of windings and the second part includes a second number of windings, the first number being different than the second number.

11. The actuator of claim 8, wherein the first set of switches is configured such that, in a default topology, the motor is in the Y-configuration.

12. The actuator of claim 8, wherein the switching array further includes a third set of switches for configuring the topology of the motor, the motor having a number of active stator poles, to eliminate half of the active stator poles of the motor.

13. The actuator of claim 12, wherein the third set of switches are configured to further eliminate half of the remaining active stator poles of the motor.

14. An actuator, comprising:
a motor with a configurable topology; and
a switching array operably coupled to the motor, the switching array adapted to configure the topology of the motor;
wherein the switching array includes a first set of switches for configuring the topology of the motor, the motor having a number of active stator poles, to eliminate half of the active stator poles of the motor and a second set of switches for configuring the topology of the motor to activate a number of windings on each of the stator poles of the motor.

15. The actuator of claim 14, wherein the number of windings on each of the stator poles includes a first part and a second part and wherein the second set of switches activates just the first part of the windings on each of the plurality of stator poles, just the second part of the windings on each of the plurality of stator poles, or both the first and second parts of the windings on each of the plurality of stator poles.

16. The actuator of claim 15, wherein the first part includes a first number of windings and the second part includes a second number of windings, the first number and the second number being different.

17. The actuator of claim 14, wherein the first set of switches are further configured to eliminate half of the remaining active stator poles of the motor.

18. The actuator of claim 14, wherein the switching array further includes a third set of switches for configuring the topology of the motor to a Y-configuration or a Δ-configuration.

19. The actuator of claim 18, wherein the third set of switches is configured such that, in a default topology, the motor is in the Y-configuration.

20. An actuator, comprising:
a motor with a configurable topology;
a switching array operably coupled to the motor, the switching array adapted to configure the topology of the motor;
a digital valve positioner (DVP) operably connected to the switching array;
wherein the switching array includes a first set of switches for configuring the topology of the motor to a Y-configuration or a Δ-configuration, a second set of switches for configuring the topology of the motor to eliminate one or more stator poles of the motor, and a third set of switches for configuring the topology of the motor to activate a number of windings on each of a plurality of stator poles of the motor; and
wherein the DVP commands switching of the first, second, and third sets of switches.

21. The actuator of claim 20, wherein the DVP is configured to command current in the windings to be zero amps and, upon reaching approximately zero amps, the controller is configured to send a command to the switching array to configure the topology of the motor.

22. The actuator of claim 20, further comprising a snubber for each switch of the first, second, and third sets of switches;
wherein the DVP is configured to send a command to the switching array to configure the topology of the motor at a non-zero current.

23. The actuator of claim 20, wherein the switching array is configured to sense a current in the windings;
wherein the DVP is configured to send a command to the switching array to configure the topology of the motor; and
wherein the switching array configures the topology of the motor when the switching array senses that the current in the windings is crossing zero amps.

24. An actuator, comprising:
a motor with a configurable topology; and
a switching array operably coupled to the motor, the switching array adapted to configure the topology of the motor;
wherein, for a given voltage, the motor topology includes at least a first set speed in a first topology, a second set speed in a second topology, and a third set speed in a third topology, each of the set speeds being a no-load, maximum speed of the motor for each of the respective topologies, the first set speed being the slowest set speed and providing the highest torque of the motor topology, the second set speed providing the fastest set speed of the motor topology, and the third set speed being faster than the first set speed.

25. An actuator, comprising:
a motor with a configurable topology; and
a switching array operably coupled to the motor, the switching array adapted to configure the topology of the motor;
wherein the motor topology includes a first set speed in a first topology and a second set speed in a second topology, each set speed being a no-load, maximum speed of the motor for each respective topology, the second set speed being between twelve and fifteen times higher than the first set speed.
